(19) United States
(12) Patent Application Publication
(10) Pub. No.: US 2016/0300677 A1
(43) Pub. Date: Oct. 13, 2016

(54) MAGNETIC SWITCH

(71) Applicant: LSIS CO., LTD., Anyang-si (KR)

(72) Inventor: Jinhee PARK, Anyang-si (KR)

(73) Assignee: LSIS CO., LTD., Anyang-si (KR)

(21) Appl. No.: 14/981,552

(22) Filed: Dec. 28, 2015

(30) Foreign Application Priority Data
Apr. 13, 2015 (KR) 10-2015-0051883

(51) Int. Cl. H01H 50/16; H01H 50/44

(52) U.S. Cl. CPC H01H 50/16; H01H 50/44; H01H 2205/002

(57) ABSTRACT

The present invention relates to a magnetic switch, and more particularly, to a magnetic switch provided with a permanent magnet disposed at an outside of an upper frame and an externally fitted permanent magnet holder to reduce a number of components and facilitate maintenance.

### CROSS-REFERENCE TO RELATED APPLICATIONS

Pursuant to 35 U.S.C. §119(a), this application claims the benefit of earlier filing date and right of priority to Korean Patent Application No. 10-2015-0051883, filed on Apr. 13, 2015, the contents of which are hereby incorporated by reference herein in its entirety.

### BACKGROUND OF THE INVENTION

1. Field of the Invention

The present invention relates to a magnetic switch, and more particularly, to a magnetic switch provided with a permanent magnet disposed at an outside of an upper frame and an externally fitted permanent magnet holder to reduce a number of components and facilitate maintenance.

2. Description of the Related Art

In general, as a type of electrical circuit switching device for transferring mechanical drives and current signals using the principle of an electromagnet, a magnetic switch or direct current relay is installed in various facilities, machines, vehicles and the like.

In particular, in case of a relay for electric vehicles, it may be located at a battery system in an electric vehicle such as a hybrid vehicle, a fuel cell vehicle, a golf cart and an electric forklift to perform the role of switching the conductivity of a main current.

A direct current relay for electric vehicles may include a high voltage portion and a low voltage portion. The high voltage (HV) portion is connected to an electric wire or bus bar to take charge of the conduction and blocking of a main current, and the low voltage (LV) portion operates a drive unit to turn on or off the direct current relay. In general, a direct current relay for electric vehicles is located within a battery system.

FIG. 1 illustrates a lateral longitudinal cross-sectional view of a magnetic switch according to the related art, and FIG. 2 illustrates an internal perspective view of an upper frame assembly in FIG. 1.

The configuration of a direct current relay for electric vehicles may include a lower frame 1, an upper frame 2, a pair of fixed contacts 3 and movable contacts 4 installed within the upper frame 2, and an electric actuator 5 installed within the lower frame 1 to drive the movable contacts 4 to allow the switching control of contacts due to an electrical signal. A permanent magnet 6a, 6b is fixed to a permanent magnet holder 7 and provided within the upper frame 2 to effectively control an arc occurring during the blocking of contacts.

The operation during the blocking will be described with reference to FIG. 3. A pair of fixed contacts 3 (3a, 3b) are configured with two main contact terminals to have a positive (+) and a negative (−) polarity. A permanent magnet 6a, 6B installed within the upper frame 2 forms a magnetic field (B), and fixed to a permanent magnet holder (not shown) to provide the path of a magnetic field. A magnetic field (B) generated from the permanent magnet 6a, 6b interacts with a current (+I, −I) to generate a force (+F, −F) of pushing an arc occurring during the switching to an outside, thereby performing the role of reducing the damage of a contact portion.

However, a magnetic switch according to the related art is assembled in such a manner that two permanent magnet holders 7 are pushed and installed into the upper frame 2 in a symmetric manner, and then permanent magnets 6a, 6b are coupled to both end portions of two permanent magnet holders 7, respectively. The reason of providing two permanent magnet holders 7 is that the operation of pushing and installing into the upper frame 2 is difficult with one integrated form of permanent magnet holder 7. In other words, there is a drawback of increasing the number of components and deteriorating the work process.

Furthermore, two permanent magnet holders 7 are pushed and installed into the upper frame 2, which is a plastic injection molded part, thereby causing a problem of suppressing the intrinsic function of permanent magnets 6a, 6b in case where the permanent magnet holders 7 are released therefrom.

Moreover, it is assembled such a manner that the permanent magnets 6a, 6b are fixed to the permanent magnet holders 7 and the permanent magnet holders 7 are pushed and installed into the upper frame 2, thereby deteriorating the disassembly performance and causing a damage on the surrounding parts during the process of performing dismantling operation when the permanent magnets 6a, 6b are removed for maintenance or the like.

### SUMMARY OF THE INVENTION

The present invention is contrived to solve the foregoing problems, and an aspect of the present invention is to provide a magnetic switch provided with a permanent magnet disposed at an outside of an upper frame and an externally fitted permanent magnet holder so as to reduce a number of components and facilitate maintenance.

A magnetic switch according to an embodiment of the present disclosure may include an upper frame formed in a box shape on which a lower surface thereof is open; a pair of fixed contacts installed in a fixed manner within the upper frame; a movable contact brought into contact with or separated from the pair of fixed contacts to conduct or block a circuit; a pair of permanent magnets disposed on part of the upper frame; and a permanent magnet holder coupled to part of the upper frame to fix the pair of permanent magnets to the upper frame, wherein a first and a second mounting portion are provided at outer sides on a front and a rear surface of the upper frame, respectively, to place the pair of permanent magnets into the first and the second mounting portion, and the permanent magnet holder is formed in a U-shape and coupled to an upper portion of the upper frame to fix the pair of permanent magnets to an outside of the upper frame.

Here, the first and the second mounting portion may have a groove formed with a width and area capable of accommodating the permanent magnet.

Furthermore, a holder insertion portion into which the permanent magnet holder can be fixed may be formed on an upper surface of the upper frame.

Furthermore, the holder insertion portion may include a groove portion formed between a pair of protrusion portions protruded in an “11” shape.

Furthermore, part of the holder insertion portion may be protruded from a front surface of the upper frame to form a support portion.

Furthermore, the permanent magnet holder may include a body portion formed to transverse an upper surface of the upper frame and bridge portions extended in a vertically downward direction at both end portions of the body portion.

Furthermore, engagement portions engaged with lower end portions of the first and the second mounting portion, respectively, may be formed in a bent manner at both end portions of the permanent magnet holder.

Furthermore, adhesion portions capable of applying a contact pressure to the permanent magnets, respectively, may be formed at both end portions of the permanent magnet holder.

In addition, a handle portion may be provided on part of the permanent magnet holder.

According to a magnetic switch according to an embodiment of the present disclosure, a permanent magnet may be coupled to an outside of the upper frame by a permanent magnet holder, thereby having an effect of facilitating the assembly and removal work. Furthermore, it may reduce possibility of damaging the surrounding components during the removal.

On the other hand, the permanent magnet holder may be configured with a single component, thereby implementing the simplification of components and reducing the manufacturing cost.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a lateral longitudinal cross-sectional view illustrating a magnetic switch according to the related art;

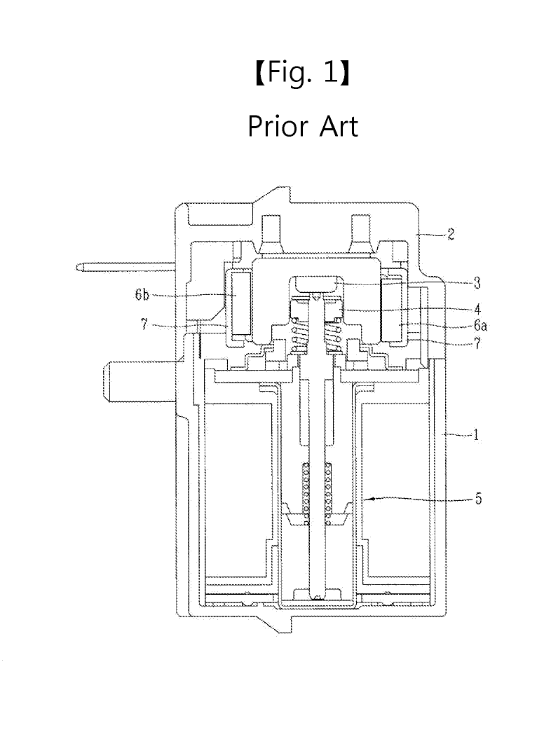

FIG. 2 is an internal perspective view illustrating an upper frame assembly in FIG. 1;

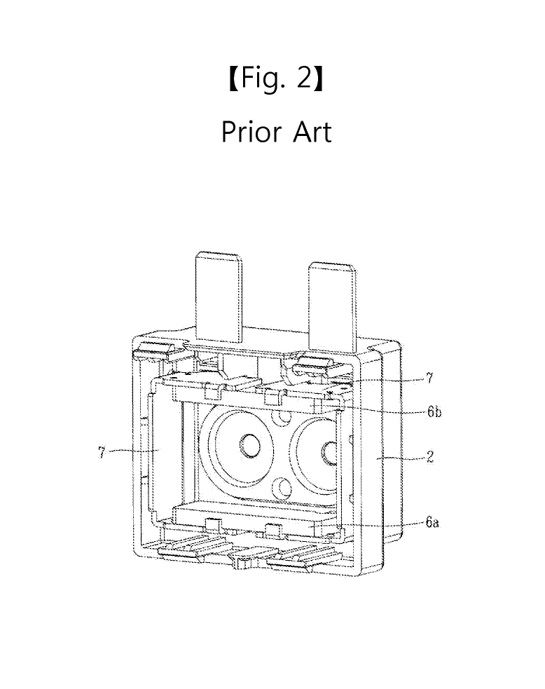

FIG. 3 is a configuration diagram illustrating an interactive relationship between a contact portion and a permanent magnet during the blocking in a magnetic switch according to the related art;

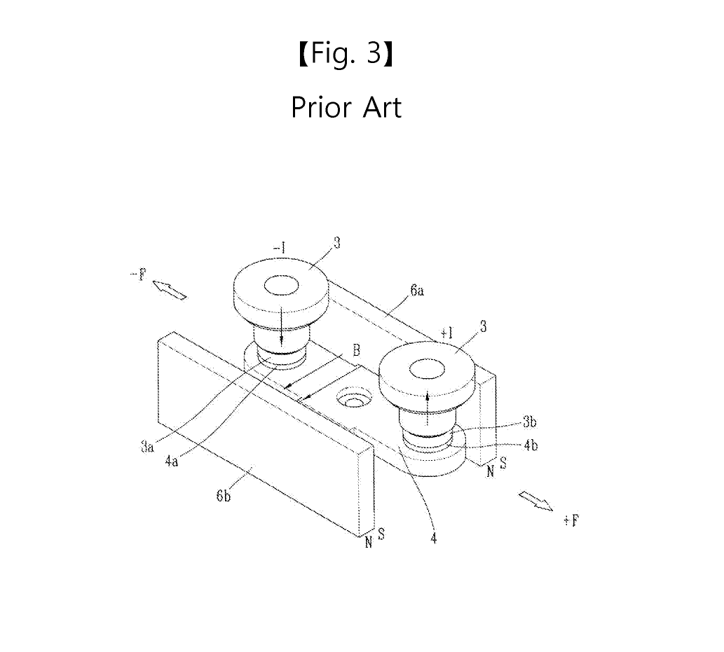

FIG. 4 is a perspective view illustrating a magnetic switch according to an embodiment of the present disclosure, in a state that a case is removed therefrom;

FIG. 5 is an exploded perspective view illustrating an upper frame assembly in FIG. 4;

FIG. 6 is a rear perspective view illustrating an upper frame in FIG. 4;

FIG. 7 is a perspective view illustrating a permanent magnet holder according to another embodiment of the present disclosure; and

FIGS. 8, 9 and 10 are perspective views illustrating a permanent magnet holder according to still another embodiment of the present disclosure, respectively.

### DETAILED DESCRIPTION OF THE INVENTION

Hereinafter, a preferred embodiment of the present invention will be described in detail with reference to the accompanying drawings to such an extent that the present invention can be easily implemented by a person having ordinary skill in the art to which the present invention pertains, but it does not mean that the technical concept and scope of the present invention are limited due to this.

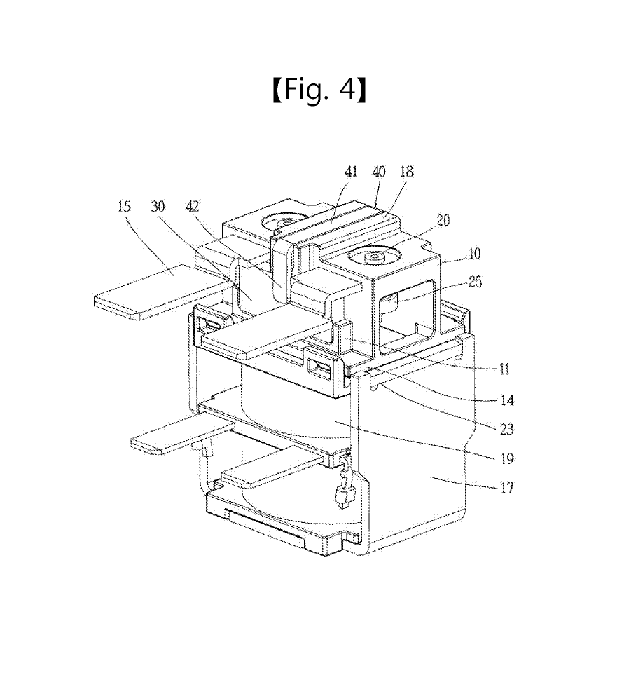

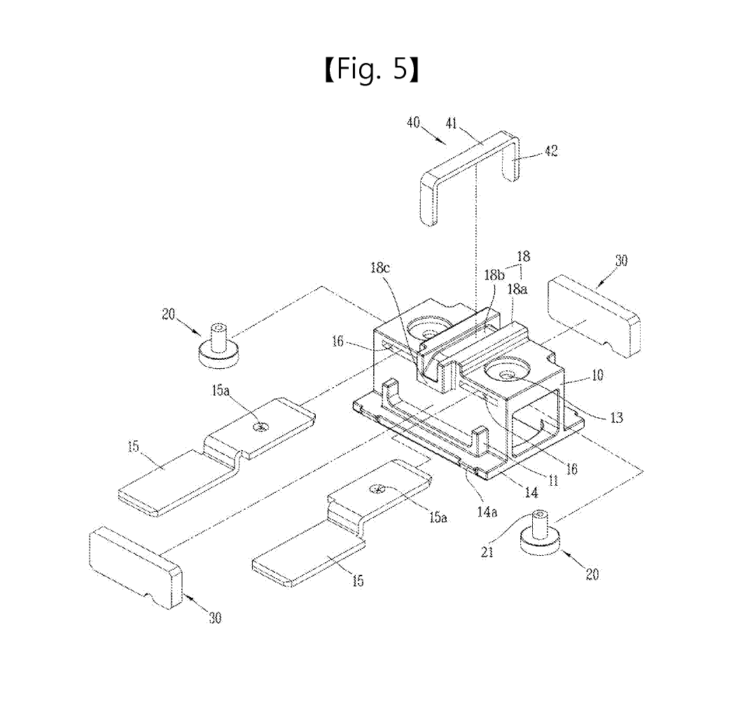

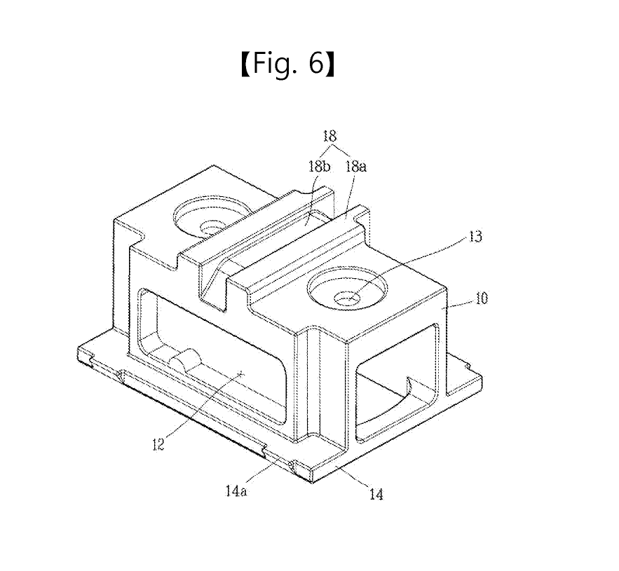

FIG. 4 illustrates a perspective view of a magnetic switch according to an embodiment of the present disclosure, and FIG. 5 illustrates an exploded perspective view of an upper frame assembly, and FIG. 6 illustrates a rear perspective view of an upper frame. A magnetic switch according to each embodiment of the present disclosure will be described in detail with reference to the accompanying drawings.

A magnetic switch according to an embodiment of the present disclosure may include an upper frame 10 formed in a box shape on which a lower surface thereof is open; a pair of fixed contacts 20 installed in a fixed manner within the upper frame 10; a movable contact 25 brought into contact with or separated from the pair of fixed contacts 20 to conduct or block a circuit; a pair of permanent magnets 30 disposed on part of the upper frame 10; and a permanent magnet holder 40 coupled to part of the upper frame 10 to fix the pair of permanent magnets 30 to the upper frame 10, wherein a first and a second mounting portion 11, 12 are provided at outer sides on a front and a rear surface of the upper frame 10, respectively, to place the pair of permanent magnets 30 into the first and the second mounting portion 11, 12, and the permanent magnet holder 40 is formed in a U-shape and coupled to an upper portion of the upper frame 10 to fix the pair of permanent magnets 30 to an outside of the upper frame 10.

The upper frame 10 may be formed in a box shape on which a lower surface thereof is open. The upper frame 10 may be formed of a synthetic resin material such as plastic. The upper frame 10 may be formed of an injection molded part.

A support surface 14 extended to a front and a rear side may be formed at a lower portion of the upper frame 10. A plurality of fixed protrusions 14a capable of fixing the upper frame 10 to a plate 23 for connecting the upper frame 10 to a lower frame 17 may be formed in a protruding manner on the support surface 14.

A pair of contact holes 13 on which the fixed contacts 20 can be installed are formed on an upper surface of the upper frame 10.

A pair of insertion grooves 16 into which a terminal 15 or bus bar connected to the fixed contact 20 can be inserted are formed on a front surface of the upper frame 10. The positions of the insertion grooves may correspond to the positions of the fixed contacts 20, respectively. Here, the terminal 15 may be formed of a material such as silver (Ag) or the like having a good conductivity. Furthermore, a through hole 15a into which the fixed contact 20 can be inserted and installed is formed on part of the terminal 15.

A first mounting portion 11 on which a permanent magnet 30 can be mounted is formed on a front surface of the upper frame 10. The first mounting portion 11 may be formed in a protruding manner in a substantially U shape at a lower portion of the upper frame 10 in consideration of a place at which the insertion grooves 16 is formed. The first mounting portion 11 has a width and area capable of accommodating the permanent magnet 30.

A second mounting portion 12 on which a permanent magnet 30 can be mounted is formed on a rear surface of the upper frame 10. The second mounting portion 12 may be formed in a protruding manner in a substantially “□” shape. An inner portion of the second mounting portion 12 has a width and area capable of accommodating the permanent magnet 30.

A holder insertion portion 18 into which a permanent magnet holder 40 can be inserted and fixed may be formed at a central portion on an upper surface of the upper frame 10. The holder insertion portion 18 may be configured with a groove portion 18b between a pair of protrusion portions 18a protruded in an “11” shape. Part of the holder insertion portion 18 may be protruded to a front surface of the upper frame 10 to form a support portion 18c. The support portion 18c along with the first mounting portion 11 supports the permanent magnet 30.

The lower frame 17 is coupled to a lower portion of the plate 23, and a coil assembly 19 and an actuator (not shown) may be installed therewithin.

A pair of fixed contacts 20 are terminals that can be inserted into the through holes 15a of the terminals 15 and the contact holes 13 of the upper frame 10 to be exposed to an outside of the upper frame 10, and connected to a power source or load. A pair of fixed contacts 20 may be formed of a material such as copper (Cu) or the like having a good conductivity. An upper end portion of the pair of fixed contacts 20 may be connected to a power source or load, and a lower end portion thereof may be brought into contact with the moving contact 25. A connecting groove 21 may be formed on an upper end portion of the pair of fixed contacts 20 to insert a contact terminal of load thereinto.

The fixed contacts 20 are inserted into the through holes 15a of the terminals 15 and the contact holes 13 of the upper frame 10 from the bottom to the top direction in a state that the terminals 15 are inserted into the insertion grooves 16 of the upper frame 10, and coupled thereto in a manner of being pressed and riveted at an upper portion in a state of being fixed and supported by a jig or the like.

The movable contact 25 is a terminal inserted into the upper frame 10 and brought into contact with and separated from a pair of fixed contacts 20. The movable contact 25 is brought into contact with a lower end portion of the foregoing pair of fixed contacts 20. The movable contact 25 is a plate-shaped body having a predetermined thickness on which a surface facing the fixed contact 20 is formed in a flat shape. The movable contact 25 may be fixed to a drive shaft (not shown) installed within the coil assembly 19, and brought into contact with or separated from a pair of fixed contacts 20 as the drive shaft is linearly driven along an axial direction. A circuit is closed to allow conduction when the movable contact 25 is brought into contact with a pair of fixed contacts 20, and the circuit is open to block the flow of a current when the movable contact 25 is separated from a pair of fixed contacts 20.

A pair of permanent magnets 30 are installed on the upper frame 10. The pair of permanent magnets 30 may be installed on the first mounting portion 11 and second mounting portion 12, respectively. Here, the position of the permanent magnet 30 corresponds to a position at which the fixed contact 20 is brought into contact with the movable contact 25 based on the height. At this time, the pair of permanent magnets 30 may be installed such that surfaces having the same polarity direct the same direction. For example, they may be installed such that the S-pole (N-pole) is directed to the front. In this manner, a magnetic field directed from the rear to the front (or directed from the front to the rear) may be formed within the upper frame 10. In general, they are installed such that an arc generated during the blocking due to an interaction between the magnetic field and a current flowing through a pair of fixed contacts 20 in an upward or downward direction, respectively, receives a force of being pushed to an outer side.

The permanent magnet holder 40 may be formed in a substantially U-shape. The permanent magnet holder 40 may be made of a steel.

The permanent magnet holder 40 may include a body portion 41 formed to transverse an upper surface of the upper frame 10 and bridge portions 42 extended in a vertically downward direction at both end portions of the body portion 41.

A distance between both the bridge portions 42 may be set to a distance that can be engaged in a fitting manner to provide a contact pressure capable of fixing a pair of permanent magnets 30 thereto in a state that that the permanent magnets 30 are coupled to the first mounting portion 11 and second mounting portion 12, respectively.

The body portion 41 may be inserted and fixed into the holder insertion portion 18 of the upper frame 10. The body portion 41 is fixed to the holder insertion portion 18 in a state that a pair of permanent magnets 30 are placed on the first and the second mounting portion 11, 12, respectively, and both the bridge portions 42 support the pair of permanent magnets 30, and thus the pair of permanent magnets 30 are stably coupled to the upper frame 10.

A pair of permanent magnets 30 may be placed on an outside of the upper frame 10, and the permanent magnet holder 40 may be coupled thereto with a simple fitting operation without the help of a jig or the like, thereby having an effect of simplifying the work process and reducing the manufacturing time compared to the related art in which they are installed within the upper frame. Furthermore, a complicated disassembly work due to tools is not required as in the related art since the disassembly work is completed by simply separating the permanent magnet holder 40 therefrom even during the disassembly work for maintenance, thereby having an effect of simplifying the work process and reducing the manufacturing time. Furthermore, according to the related art, there is a possibility of deteriorating the disassembly work of permanent magnets and damaging the surrounding components during the process of using a tool or the like, but a magnetic switch according to an embodiment of the present disclosure has an effect of significantly reducing the possibility of damage.

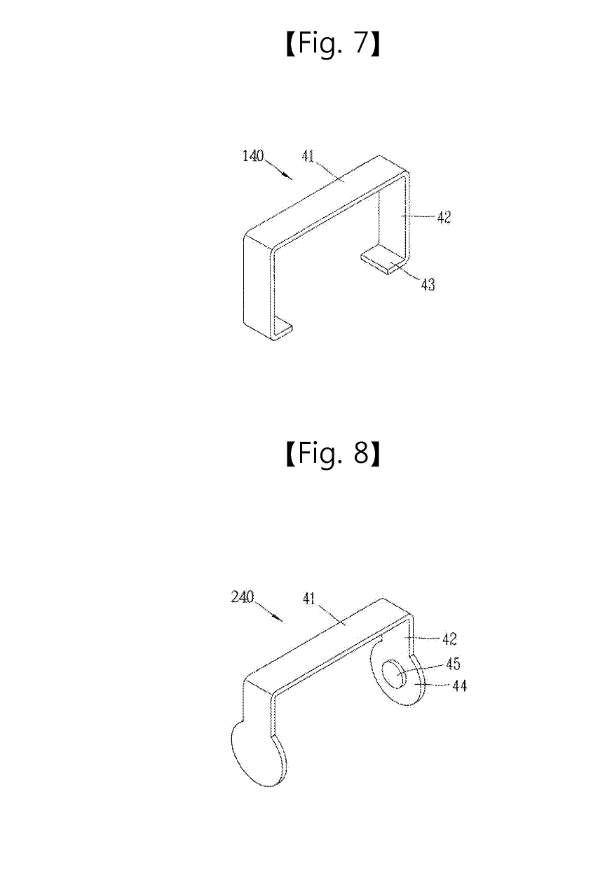

FIG. 7 illustrates a perspective view of a permanent magnet holder according to another embodiment of the present disclosure. According to the present embodiment, the permanent magnet holder 140 is formed such that an engagement portion 43 is bent in an inward direction at a lower end of the bridge portion 42. The permanent magnet 30 is more stably fixed by the engagement portion 43 engaged with a lower portion of the first and the second mounting portion 12 to prevent the permanent magnet 30 from being released during use.

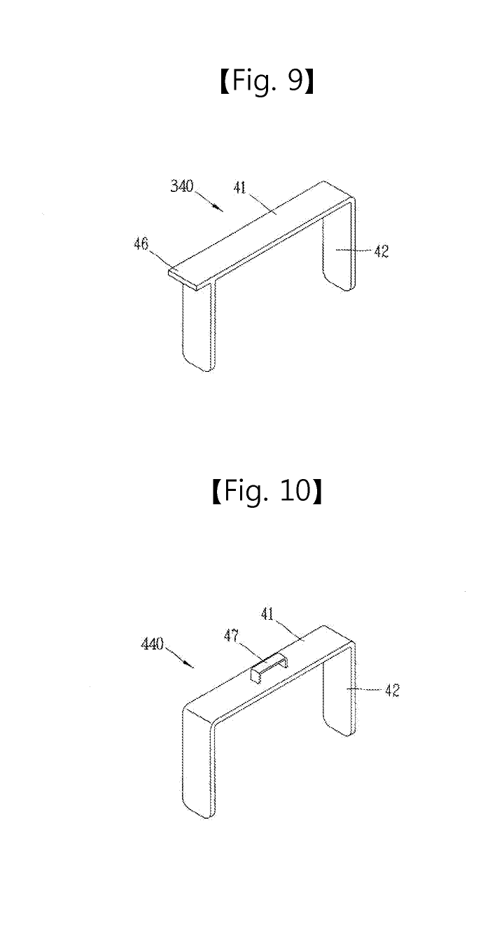

FIG. 8 illustrates a perspective view of a permanent magnet holder according to still another embodiment of the present disclosure. According to the present embodiment, an adhesion portion 44 is formed at a lower end of the bridge portion 42 of the permanent magnet holder 240. The width of the adhesion portion 44 is formed to be larger than that of the bridge portion 42 to increase a contact area to the permanent magnet 30. Accordingly, it has an effect of increasing a force supporting the permanent magnet 30. According to the embodiment, a contact pressure portion 45 formed in a protruding manner may be provided at an inner side of the adhesion portion 44 to further increase a contact pressure force to the permanent magnet 30.

FIGS. 9 and 10 illustrate perspective views of a permanent magnet holder according to still yet another embodiment of the present disclosure. According to the present embodiment, a permanent magnet holder 340, 440 may include a handle portion 46, 47 formed on part of the body portion 41. The handle portion 46, 47 allows an effect of more easily performing a release operation when releasing the permanent magnet holder 340, 440.

According to a magnetic switch according to an embodiment of the present disclosure, a permanent magnet may be coupled to an outside of the upper frame by a permanent magnet holder, thereby having an effect of facilitating the assembly and removal work. Furthermore, it may reduce possibility of damaging the surrounding components during the removal.

On the other hand, the permanent magnet holder may be configured with a single component, thereby implementing the simplification of components and reducing the manufacturing cost.

It will be apparent to those skilled in this art that various changes and modifications may be made thereto without departing from the gist of the present invention. Accordingly, it should be noted that the embodiments disclosed in the present invention are only illustrative and not limitative to the concept of the present invention, and the scope of the concept of the invention is not limited by those embodiments. The scope protected by the present invention should be construed by the accompanying claims, and all the concept within the equivalent scope of the invention should be construed to be included in the scope of the right of the present invention.

What is claimed is:

1. A magnetic switch, comprising:
an upper frame formed in a box shape on which a lower surface thereof is open;
a pair of fixed contacts installed in a fixed manner within the upper frame;
a movable contact brought into contact with or separated from the pair of fixed contacts to conduct or block a circuit;
a pair of permanent magnets disposed on part of the upper frame; and
a permanent magnet holder coupled to part of the upper frame to fix the pair of permanent magnets to the upper frame,
wherein a first and a second mounting portion are provided at outer sides on a front and a rear surface of the upper frame, respectively, to place the pair of permanent magnets into the first and the second mounting portion, and
the permanent magnet holder is formed in a U-shape and coupled to an upper portion of the upper frame to fix the pair of permanent magnets to an outside of the upper frame.

2. The magnetic switch of claim 1, wherein the first and the second mounting portion have a groove formed with a width and area capable of accommodating the permanent magnet.

3. The magnetic switch of claim 1, wherein a holder insertion portion into which the permanent magnet holder can be fixed is formed on an upper surface of the upper frame.

4. The magnetic switch of claim 3, wherein the holder insertion portion comprises a groove portion formed between a pair of protrusion portions protruded in an “11” shape.

5. The magnetic switch of claim 3, wherein part of the holder insertion portion is protruded from a front surface of the upper frame to form a support portion.

6. The magnetic switch of claim 1, wherein the permanent magnet holder comprises a body portion formed to transverse an upper surface of the upper frame and bridge portions extended in a vertically downward direction at both end portions of the body portion.

7. The magnetic switch of claim 1, wherein engagement portions engaged with lower end portions of the first and the second mounting portion, respectively, are formed in a bent manner at both end portions of the permanent magnet holder.

8. The magnetic switch of claim 1, wherein adhesion portions capable of applying a contact pressure to the permanent magnets, respectively, are formed at both end portions of the permanent magnet holder.

9. The magnetic switch of claim 1, wherein a handle portion is provided on part of the permanent magnet holder.
